(19) United States
(12) Patent Application Publication
(10) Pub. No.: US 2017/0247171 A1
(43) Pub. Date: Aug. 31, 2017

(54) UNFILLED LIQUID RESERVOIR, DISPENSER WITH SUCH A RESERVOIR, AND FILLING METHOD

(71) Applicant: Juergen GREINER-PERTH, Gottmadingen (DE)

(72) Inventor: Juergen GREINER-PERTH, Gottmadingen (DE)

(21) Appl. No.: 15/504,163

(22) PCT Filed: Aug. 12, 2015
(86) PCT No.: PCT/EP2015/068587

§ 371 Date: Feb. 15, 2017

(30) Foreign Application Priority Data
Aug. 28, 2014 (EP) 14182729.5

(51) Int. Cl. B65D 83/00; B05B 11/04; A61J 1/14; B67D 7/02; B65B 39/00; A45D 34/00

(52) U.S. Cl. CPC B65D 83/0055; B65B 39/00; A45D 34/00; A61J 1/1443; B67D 7/02; B05B 11/048

(57) ABSTRACT

An unfilled liquid reservoir for use as part of a dispenser for dispensing pharmaceutical or cosmetic liquids, including an outer housing for placing on a dispensing head of the dispenser and a flexible bag arranged within the outer housing for receiving liquid before the dispensing process. The bag has an opening for removing the liquid, and an intermediate region between the outer housing and the bag is connected to a surrounding area by a ventilation opening which passes through a wall of the outer housing. The flexible bag is provided in a stowed storage state in which the inner volume of the bag is maximally 10% of the maximum inner volume of the bag within the outer housing.

### FIELD OF USE AND PRIOR ART

The invention relates to an unfilled liquid reservoir for use as part of a dispenser for discharging pharmaceutical or cosmetic liquids, to a dispenser comprising an unfilled liquid reservoir of this kind, and to a method for filling a flexible bag of an unfilled liquid reservoir.

An unfilled liquid reservoir of the type in question comprises an outer housing for mounting on a discharging head of the dispenser, and a flexible bag which is arranged inside the outer housing and serves to receive liquid before the discharging procedure, said bag having a bag opening for removal of the liquid. In an unfilled liquid reservoir of the type in question, an intermediate area between the outer housing and the bag is connected to the environment by a ventilation opening that passes through a wall of the outer housing.

Dispensers of the type in question with unfilled liquid reservoirs of the type in question are known from the prior art. These are dispensers or liquid reservoirs in their delivery state, in which state they are delivered for filling, during the course of which the bag is filled with liquid.

These liquid reservoirs, which have an outer housing with a ventilation opening and have a bag inserted therein, make it possible to avoid direct contact between air and the stored liquid during operation. The liquid is arranged in the bag, the latter having flexible walls and therefore being able to collapse, without appreciable restoring forces, as more and more liquid is removed. To ensure that the reduction in the amount of liquid in the bag does not lead to a negative pressure, said ventilation opening is provided, which allows compensating air to flow in through the ventilation opening. As the emptying of the bag proceeds, the outer volume of the bag is thus reduced, while the volume of the intermediate area increases, wherein the air flowing in results in a pressure compensation in the intermediate area.

In known unfilled liquid reservoirs with a bag of the kind described, the bag is filled with air before the liquid is introduced. During the introduction of the liquid, this air is displaced and forced out through the ventilation opening. However, it was found that complete displacement of the air is difficult. Air inclusions in most cases remain in the area of the bag opening and sometimes also at other areas of the bag. Moreover, the liquid being introduced and flowing into the bag necessarily comes into contact in the meantime with the air located therein.

Whereas contact with air is mostly unproblematic in the case of liquids containing preservatives, it should be avoided as far as possible in the case of liquids that are without preservatives.

### PROBLEM AND SOLUTION

The problem addressed by the invention is therefore to make available an unfilled liquid reservoir which is of the type in question and by means of which the risk of contamination caused by unclean air during the filling procedure, and thereafter, can be avoided as far as possible.

According to the invention, this problem is solved by the fact that the the flexible bag of the unfilled liquid reservoir, before being filled, is provided in a compact stowage state in which the inner volume of the bag is at most 10% of the maximum inner volume of the bag inside the outer housing.

According to the invention, provision is therefore made that, before being filled with liquid, the flexible bag has a small volume compared to the filled state. The maximum inner volume of the bag, which constitutes the scale, is defined by the shape of the bag and/or by the inner shape of the outer housing. The maximum inner volume of the bag is the one which, during the filling of the bag inside the outer housing, is the greatest attainable before the bag fails. In dispensers of the type in question, this maximum inner volume is preferably between 3 cl and 20 cl. According to the invention, the inner volume of the bag in the compact stowage state is at most 10% thereof. In particular, it is advantageous if the inner volume is still further reduced, preferably to a maximum of 5%, particularly preferably to a maximum of 2%, of the maximum inner volume of the bag. The quantity of the air that is located in the bag, and that could cause contamination of the liquid, is therefore very small.

The expression unfilled liquid reservoir, or unfilled bag, denotes a completely unfilled liquid reservoir as is present after production and prior to filling. In this state, the liquid reservoir is completely empty and also free of residual liquid. The expression does not signify the liquid reservoir after it has been emptied as intended, in which state it always still contains residues of the liquid, in corners and on walls, which are usually disposed of together with other parts of the dispenser.

It is particularly advantageous if the bag in the compact stowage state is almost evacuated. This is understood as meaning that its inner volume is at most 1% of the maximum inner volume of the bag.

The bag itself preferably comprises dimensionally flexible walls made of plastic or of a thin metal foil or a composite material with a plastic layer and/or a metal foil layer. These walls of the bag preferably form a bag unit in conjunction with a headpiece. In such a case, they are secured on the rigid headpiece. The headpiece preferably provides the bag opening and serves for the attachment of a filling nozzle for the liquid. The abovementioned maximum and minimum inner volumes of the bag relate to the volume starting from the bag opening and, in the presence of a rigid headpiece of the bag unit, to the inwardly facing end of the ventilation opening passing through the headpiece. Moreover, the headpiece is preferably provided with holding surfaces which, in a defined position, can be secured or placed on an inner side of the outer housing of the unfilled liquid reservoir in order to establish a relative position between the bag and the outer housing. It is possible in principle to provide the bag in a simply evacuated state. However, since the walls of the bag are sometimes not entirely free of restoring forces, this has the effect that the bag has a tendency to increase its inner volume and to draw in air before the process of introducing liquid has begun. To prevent this, various compact stowage states are advantageous.

In one possible configuration, provision is made that the bag in the compact stowage state is folded at least along one fold edge. This has the effect that the walls of the bag in the compact stowage state have no direct tendency to increase the inner volume of the bag. This effect can be further improved by means of two or more mutually parallel fold edges along which the flexible bag is folded. The one or more fold edges preferably extend parallel to the orientation of the bag opening, which for its part, given the normally cylindrical shape of the outer housing, is oriented parallel to the main axis of the outer housing.

Instead of comparatively sharp fold edges, another configuration of a compact stowage state is one in the shape of a roll. In this case, an eccentric side area of the bag or preferably two opposite side areas of the bag is/are rolled up in relation to a roll axis, this roll axis preferably being oriented parallel to or in alignment with the orientation of the bag opening. To facilitate the production of such a roll, the rigid headpiece is preferably provided with a cylindrical portion, at which the flexible walls of the bag are connected to the headpiece and through which the bag opening extends. This cylindrical portion defines the internal diameter of the windings of the roll that are formed by the side areas of the bag. The extension piece can in this case have a circular cylindrical outer shape. However, an approximately elliptic shape is advantageous.

To ensure that no air or only a small amount of air can get into the bag prior to the process of filling the latter with liquid, it may be advantageous for the bag in the compact stowage state to be closed in an airtight manner. This can be done, for example, by mutually opposite walls of the flexible bag in the area of the bag opening being connected to each other by an adhesive bond or the like, in such a way that the bag is insulated in an airtight manner until this adhesive bond is broken open directly before the filling procedure. Alternatively, it is also conceivable to close the bag opening with a membrane or the like which is pierced prior to or during the filling procedure.

It has been found that the admission of air prior to filling the bag with liquid can also be effectively prevented by the provision of fixing means, by means of which the bag is held in the compact stowage state. These fixing means are fitted on the flexible bag in such a way as to prevent the latter departing from the compact stowage state. In the case of a roll shape, circumferential holding strips, for example made of paper or simple adhesive tape, can preferably prevent the bag from opening out. A circumferential strip of this kind preventing unwanted opening-out of the bag can also be used in the case of a bag that is folded up at one, two or more fold edges. The holding strip does not need to have any special stability and can in particular be made weak such that it deliberately tears during filling of the bag. For this purpose, the strip is designed in such a way that it preferably fails at a tensile force of over 0.5 N.

Instead of being in the form of a holding strip, the fixing means can also take the form of adhesive surfaces which are provided on the outside of the flexible walls of the bag and by which two areas of the outside of the flexible bag are fixed to each other in the compact stowage state. In this case too, it is advantageous to use fixing means that can be released simply by liquid being introduced into the bag.

The ventilation opening provided in the outer housing is preferably provided on the bottom of the latter. It has to allow exchange of air in the space between bag and outer housing. The ventilation opening is preferably provided with a filter device, for example with a membrane whose pore size is suitable for the decontamination of the air that flows in.

Besides the unfilled liquid reservoir itself, the invention also relates to a dispenser for discharging pharmaceutical or cosmetic liquids, comprising a discharging head with a discharging opening, through which liquid from a liquid reservoir can be dispensed to the environment, and a liquid reservoir according to the invention as described above. This dispenser, with the liquid reservoir still unfilled, is preferably delivered in the unassembled state, that is to say with the discharging head not yet fitted, such that disassembly can be dispensed with before filling the liquid bag. The discharging head is preferably fitted only after the bag has been filled. To couple the discharging head to the liquid reservoir, coupling devices are preferably provided on the discharging head and on the liquid reservoir. These coupling devices can be in the form of corresponding locking surfaces. It is particularly advantageous if a circumferential locking groove or a circumferential locking web is provided on the inside of the outer housing of the liquid reservoir and can be coupled with form-fit engagement to the discharging head.

The dispenser according to the invention is provided in particular for pharmaceutical liquids and semi-solids, particularly for those applied to the skin, and is thus filled with these in the state when delivered. These are locally or systemically acting substances (topical or transdermal). They are in particular pharmaceutical liquids and semi-solids for treating inflammatory diseases of the skin (dermatitis, psoriasis, rosacea), whatever their origin, skin infections (warts, other viral or bacterial infections, parasites), allergic reactions and diseases (atopic dermatitis, allergic skin reactions), diseases that are wholly or partly attributable to metabolic or hormonal changes (acne, hormone replacement therapies, alopecia, rosacea), and treatments of dry skin (ichthyosis and preforms). The following molecular groups in particular play a role here: caustic agents (wart removal agents such as trichloroacetic acid, salicylic acid), photosensitizers (e.g. psoralene), substances for moisture control (e.g. urea, hyaluronic acid derivatives), anti-inflammatory agents (e.g. zinc derivatives, corticosteroids), modulators of the immune system (e.g. corticosteroids, imiquimod, calcineurin inhibitors such as macrolactam, tacrolimus, pimecrolimus), irnidazoline and triazole derivatives (e.g. brimonidine, clotrimazole, ketoconazole, miconazole), allylamine derivatives, antiviral agents (e.g. docosanol, purine analogs such as acyclovir and pencyclovir), anti-parasitic agents (e.g. avermectin derivatives, praziquantel), substances used to treat hair loss (e.g. minoxidil, 5-alpha reductase inhibitor), substances for treatment of wounds (e.g. saline solution, hyaluronic acid derivatives, bioactive substances), and combinations of active substances from traditional medicine.

The invention also relates to a batch of liquid reservoirs for being subsequently filled and assembled to form a dispenser with liquid reservoirs and a discharging head, wherein the liquid reservoirs are each configured in the manner described above.

Such a batch is understood as a common delivery unit consisting of several liquid reservoirs, in particular consisting of more than 10 or more than 100 liquid reservoirs, which form a common packaging unit, in which form they are delivered to the production site where the filling procedure takes place.

The invention furthermore relates to a method for filling a flexible bag of an unfilled liquid reservoir, provision being made in this method that a filling nozzle is tightly attached to a bag opening of the bag, wherein the inner volume of the bag at this point is at most 10% of the maximum inner volume of the bag inside an outer housing of the liquid reservoir, and liquid is introduced through the filling nozzle into the bag, during the course of which air is displaced from an intermediate area between the bag and the outer housing. The inner volume of the bag is accordingly increased at least ten-fold during the filling procedure.

In said method, provision can additionally be made that fixing means on the bag are removed or released before the liquid is introduced through the filling nozzle, or these fixing means are released during the filling process. Moreover, provision can be made that, upon attachment of the filling nozzle, the bag can be opened by piercing a membrane or by opening an occlusive adhesive surface. The displaced air between the bag and the outer housing is preferably delivered to the environment through a ventilation opening that passes through a wall of the outer housing.

### BRIEF DESCRIPTION OF THE DRAWINGS

Further aspects and advantages will become clear from the following description of preferred illustrative embodiments of the invention and also from the claims.

FIGS. 1a and 1b show a first embodiment of an unfilled liquid reservoir.

FIG. 1c shows this liquid reservoir in the filled state.

FIGS. 2a to 2c show the bag unit of the liquid reservoir in the compact stowage state and in the filled state.

FIG. 3 shows a dispenser with a liquid reservoir which was configured according to the invention before being filled.

FIG. 4 shows an alternative embodiment of a bag unit.

### DETAILED DESCRIPTION OF THE ILLUSTRATIVE EMBODIMENTS

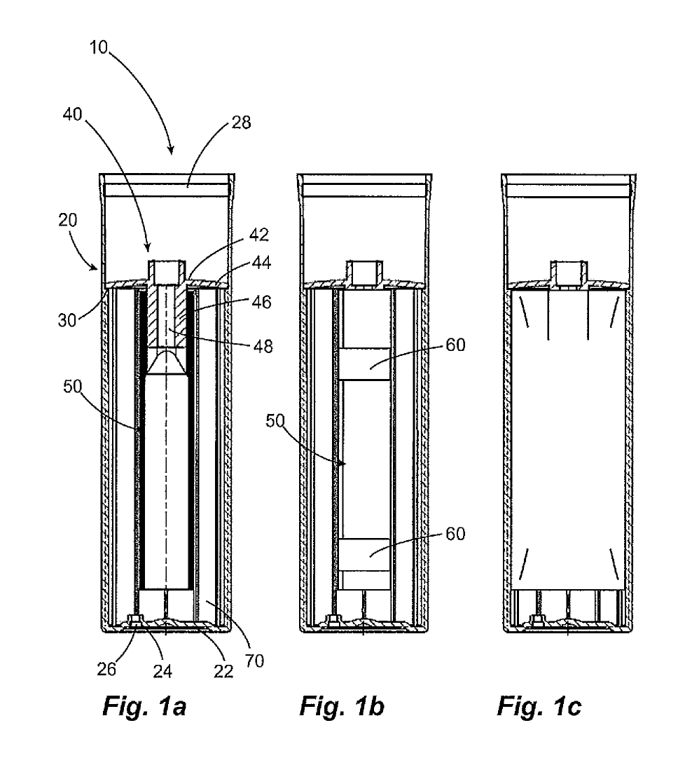

FIGS. 1a and 1b show a liquid reservoir according to the invention in section and in partial section. The liquid reservoir 10 has a rigid outer housing 20, which is preferably made from plastic. A ventilation opening 24, which is preferably provided with a microbe filter 26, is provided at the bottom 22 of this outer housing. On its inside, the outer housing 20 has, in the area of an upper open end, a coupling device 28 in the form of a locking groove. Moreover, the outer housing 20 has a supporting edge 30 on its inside.

The liquid reservoir 10 also has a bag unit 40, which comprises a headpiece 42, made of rigid plastic, and a dimensionally flexible bag 50. The headpiece 42 comprises a supporting plate 44, the outer edges of which have a shape corresponding the supporting edge 30 of the outer housing 20 and, together with said edge, form a preferably airtight seal. Moreover, the headpiece 40 has a cylindrical extension piece 46, through which there runs a bag opening 48.

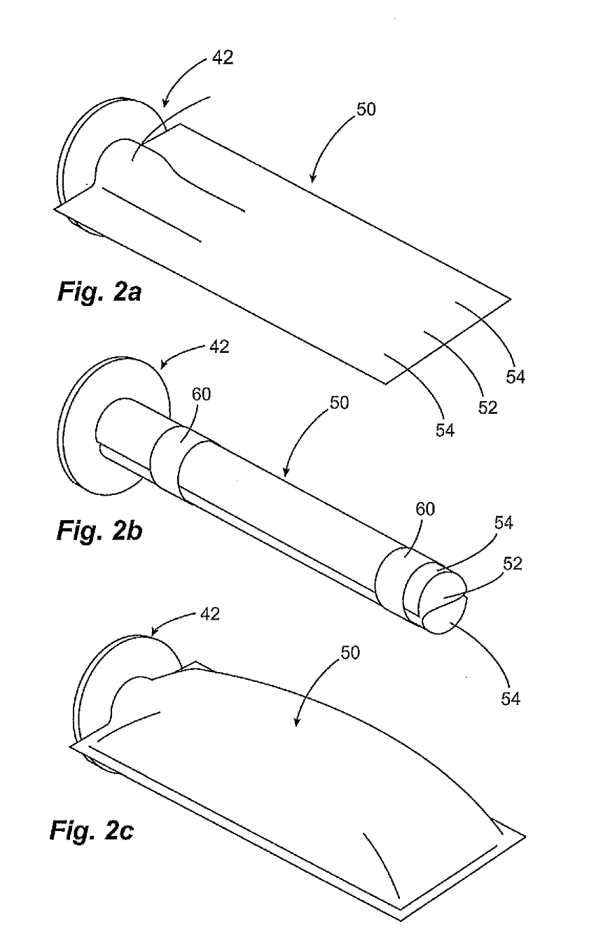

Referring to FIG. 2b, it will be noted that the dimensionally flexible bag 50 is rolled up in the stowage state. A central area 52 is, at its end pointing toward the headpiece 40, adhesively bonded or laminated onto the outside of the extension piece 46. Two lateral wings 54 of the flexible bag 50 are each rolled counterclockwise around the extension piece 46 and are additionally fixed with circumferential holding strips 60.

FIG. 2a illustrates how the flexible bag 50 looks before production of the roll according to FIG. 2b. Although the inner volume of the flexible bag 50 is identical in the state of FIG. 2a and in the state of FIG. 2b, there is much less danger, in the state in FIG. 2b, of air undesirably entering the flexible bag 50, since the tendency of the latter to increase its inner volume is reduced by the roll shape and by the holding strips 60.

FIG. 1c shows the liquid reservoir in the filled state. Its shape is illustrated once again by FIG. 2c. The inner volume of the bag 50 filled with liquid is considerably greater than that of the unfilled bag 50. The liquid bag shown has a maximum inner volume inside the outer housing of 20 cl. By contrast, the inner volume before filling, i.e. in the state shown in FIGS. 1a and 2a, is less than 0.4 cl and therefore less than 2% of the maximum volume.

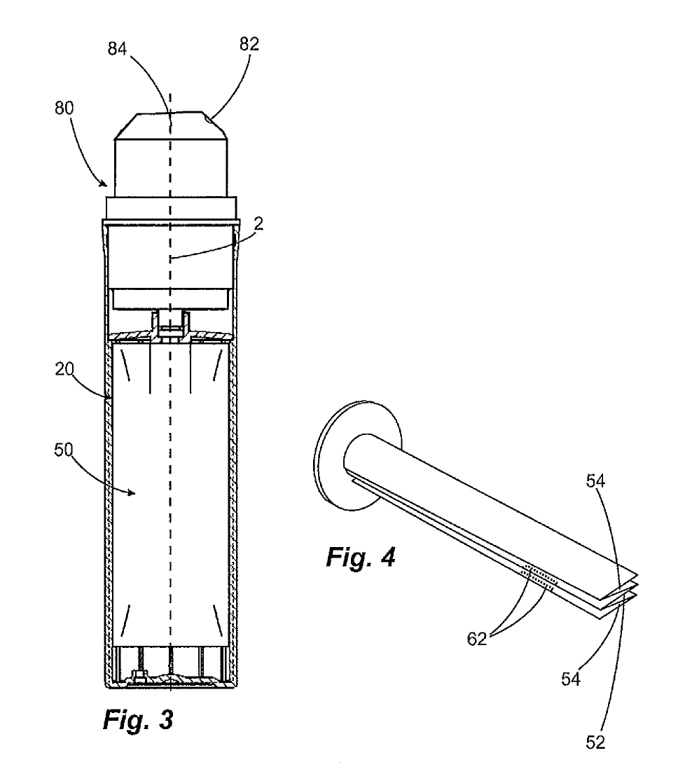

FIG. 3 shows the dispenser in the assembled state after the liquid reservoir 50 has been filled. The discharging head 80 is now mounted on the outer housing 20, said discharging head having a discharging opening 82 on an actuation button 84 that is movable in the main direction of extent 2.

In operation, by actuation of the actuation button 84 and of a pump (not shown), the liquid can be removed in steps from the liquid bag 50. The latter in this way loses volume. To ensure that a negative pressure does not develop inside the outer housing 20, compensating air is drawn in through the ventilation opening 24.

FIG. 4 shows an alternative configuration of the bag unit in the compact state. Here, lateral areas 54 of the bag are laid on top of each other by formation of double folds, such that a compact stowage state likewise results. Holding strips (not shown in FIG. 4) are able to hold the bag in the position illustrated. An alternative to such holding strips takes the form of adhesive surfaces 62, which are indicated by broken lines in FIG. 4 and by which the several layers of the folded bag 50 can be fixed to each other. The adhesive surfaces can be made sufficiently weak to ensure that they come loose without any further difficulty as the bag is being filled.

1. An unfilled liquid reservoir for use as part of a dispenser for discharging pharmaceutical or cosmetic liquids, comprising
an outer housing for mounting on a discharging head of the dispenser, and
a flexible bag which is arranged inside the outer housing and serves to receive liquid before the discharging procedure, said bag having a bag opening for removal of the the liquid,
wherein
an intermediate area between the outer housing and the bag is connected to the environment by a ventilation opening that passes through a wall of the outer housing,
wherein
the flexible bag is provided in a compact stowage state in which the inner volume of the bag is at most 10% of the maximum inner volume of the bag inside the outer housing.

2. The unfilled liquid reservoir as claimed in claim 1, wherein the bag in the compact stowage state is arranged in a form folded at least along one fold edge, wherein the bag is preferably folded twice along two mutually parallel fold edges.

3. The unfilled liquid reservoir as claimed in claim 2, wherein the at least one fold edge is oriented parallel to or in alignment with the orientation of the bag opening.

4. The unfilled liquid reservoir as claimed in claim 1, wherein the bag in the compact stowage state is provided in the form of a roll.

5. The unfilled liquid reservoir as claimed in claim 4, wherein the roll is rolled up in relation to a roll axis that is oriented parallel to or in alignment with the orientation of the bag opening.

6. The unfilled liquid reservoir as claimed in claim 1, wherein the bag is closed in an airtight manner.

7. The unfilled liquid reservoir as claimed in claim 1, wherein fixing means are provided, by means of which the bag is held in the compact stowage state, wherein the fixing means are provided in particular in the form of holding strips which engage at least regionally around the bag.

8. A batch comprising a plurality of liquid reservoirs for being subsequently filled and assembled to form a dispenser with liquid reservoirs and a discharging head, wherein the liquid reservoirs are each configured as claimed in claim 1.

9. A dispenser for discharging pharmaceutical or cosmetic liquids, comprising
an as yet unfilled liquid reservoir for receiving the liquid intended to be discharged, and a discharging head with a discharging opening through which liquid from the liquid reservoir can be dispensed to the environment,
wherein the unfilled liquid reservoir is configured as claimed in claim 1.

10. A method for filling a flexible bag of an unfilled liquid reservoir as claimed in claim 1, wherein
a filling nozzle is tightly attached to a bag opening of the bag, wherein the inner volume of the bag at this point is at most 10% of the maximum inner volume of the bag inside an outer housing of the liquid reservoir, and
liquid is introduced through the filling nozzle into the bag, during which air is displaced from an intermediate area between the bag and the outer housing.
